(19) United States
(12) Patent Application Publication
(10) Pub. No.: US 2025/0296426 A1
(43) Pub. Date: Sep. 25, 2025

(54) DRIVE DEVICE

(71) Applicant: TOYOTA JIDOSHA KABUSHIKI KAISHA, Toyota-shi (JP)

(72) Inventors: Kazuki AKIMOTO, Nisshin-shi (JP); Tomoaki SUZUKI, Nagoya-shi (JP)

(73) Assignee: TOYOTA JIDOSHA KABUSHIKI KAISHA, Toyota-shi (JP)

(21) Appl. No.: 19/000,726

(22) Filed: Dec. 24, 2024

(30) Foreign Application Priority Data
Mar. 21, 2024 (JP) 2024-045040

(51) Int. Cl. B60K 11/00; B60K 1/00

(52) U.S. Cl. CPC B60K 11/00; B60K 2001/006

(57) ABSTRACT

A housing case, a rotary electric machine provided in the housing case, a gear rotatably provided in the housing case, and a refrigerant for cooling the rotary electric machine are provided, and the housing case is provided with a housing chamber for housing the rotary electric machine and the gear, and the housing case includes a plate provided in the housing chamber and a displacement member for displacing the plate. A drive device, wherein a plate is displaced between a position in contact with an inner surface of a housing case defining a housing chamber and a position in contact with an inner surface, and a plate is in contact with an inner surface defining a housing chamber, and the refrigerant passes through the plate.

### CROSS-REFERENCE TO RELATED APPLICATION

This application claims priority to Japanese Patent Application No. 2024-045040 filed on Mar. 21, 2024, incorporated herein by reference in its entirety.

### BACKGROUND

### 1. Technical Field

The present disclosure relates to a drive device.

### 2. Description of Related Art

For example, Japanese Unexamined Patent Application Publication No. 2020-091001 (JP 2020-091001 A) discloses a drive device including a lubricating oil circuit formed of an oil tank, a pump, an oil cooler, a motor, and a gear. Lubricating oil cools the gear and the motor. Heat taken away by the lubricating oil by the cooling of the gear and the motor is used for cooling the motor and the gear again through the cooling by the oil cooler.

### SUMMARY

The drive device disclosed in JP 2020-091001 A is mounted on, for example, a battery electric vehicle. Since the battery electric vehicle is not provided with a main heating element such as an engine, it is known to use heat generated from the drive device when increasing the temperature of a device such as a battery.

In the drive device of JP 2020-091001 A, however, the heat taken away by the lubricating oil from the gear and the motor is dissipated from a case of the drive device, and thus the effective use of the heat is not considered.

The present disclosure has been made to solve the above problem, and an object thereof is to provide a drive device capable of effectively utilizing heat generated from the drive device as necessary.

A drive device according to a first aspect of the present disclosure includes a housing case, a rotary electric machine provided in the housing case, a gear rotatably provided in the housing case, and a refrigerant for cooling the rotary electric machine. The housing case has a housing chamber that houses the rotary electric machine and the gear. The housing case includes a plate provided in the housing chamber, and a displacement member configured to displace the plate. The plate is displaceable between a position where the plate is in contact with an inner surface of the housing case that defines the housing chamber and a position where a clearance is secured between the plate and the inner surface. The refrigerant passes along the plate while the plate is at the position where the plate is in contact with the inner surface that defines the housing chamber.

In the drive device according to the first aspect of the present disclosure, the refrigerant passes along the clearance while the clearance is secured between the plate and the inner surface.

In the drive device according to the first aspect of the present disclosure, the housing chamber includes a first housing chamber that houses the rotary electric machine, and a second housing chamber that houses the gear. The housing case includes a partition wall that defines the first housing chamber and the second housing chamber. The partition wall has a first opening and a second opening positioned below the first opening. The plate is provided on a bottom side of the second housing chamber. While the plate is in contact with the inner surface, the second opening is closed by the plate, and the refrigerant flows into the second housing chamber through the first opening and flows along an upper surface of the plate positioned in the second housing chamber. While the clearance is secured between the inner surface and the plate, the second opening communicates with the clearance, and the refrigerant passes along the clearance through the second opening.

The displacement member of the drive device according to the first aspect of the present disclosure is configured to, when a temperature of the refrigerant increases, displace the plate into contact with the inner surface of the housing case. A temperature of the refrigerant while the plate is in contact with the inner surface of the housing case that defines the housing chamber is higher than a temperature of the refrigerant while the clearance is secured between the plate and the inner surface of the housing case that defines the housing chamber.

A drive device according to a second aspect of the present disclosure includes a housing case, a rotary electric machine provided in the housing case, a gear rotatably provided in the housing case, a refrigerant for cooling the rotary electric machine, and a switching device. The housing case has a housing chamber that houses the rotary electric machine and the gear. The housing case includes a plate provided in the housing chamber. The plate is disposed in the housing chamber, and a clearance is secured between the plate and an inner surface of the housing case. The switching device is configured to switch a state in which the refrigerant passes along the clearance and a state in which the refrigerant does not pass along the clearance. A temperature of the refrigerant in the state in which the refrigerant passes along the clearance is higher than a temperature of the refrigerant in the state in which the refrigerant does not pass along the clearance.

According to the present disclosure, it is possible to provide the drive device capable of effectively utilizing the heat generated from the drive device as necessary.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a heat management device mounted on a vehicle according to the present embodiment;

FIG. 2 is a perspective view of a drive device according to the present embodiment;

FIG. 3 is a cross-sectional view of III-III section of FIG. 2;

FIG. 4 is a perspective view schematically showing a plate;

FIG. 5 is a cross-sectional view illustrating an exemplary embodiment in which the plate position is displaced about the rotation shaft; and

FIG. 6 is a cross-sectional view of a drive device according to a modification of the present embodiment.

### DETAILED DESCRIPTION OF EMBODIMENTS

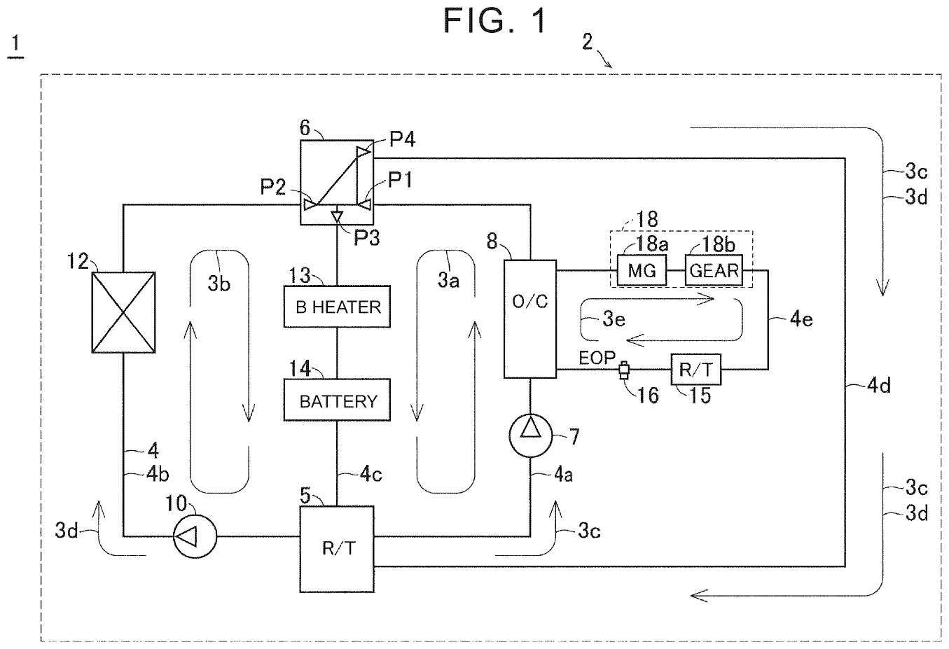

FIG. 1 is a diagram illustrating a schematic configuration of a heat management device mounted in a vehicle according to the present embodiment. The vehicles 1 are electrified vehicle (xEV). The vehicles 1 are BEV (battery electric vehicle). However, the vehicle 1 may be, for example, an industrial vehicle, or may be another electrified vehicle such as a plug-in hybrid electric vehicle. The vehicle 1 is equipped with a heat management device 2.

The heat management device 2 has a circuit 3. A heat medium circulates in the heat management device 2. The circuit 3 includes a first circuit 3a, a second circuit 3b, a third circuit 3c, and a fourth circuit 3d.

The first circuit 3a includes a first flow path 4a, a third flow path 4c, a reservoir tank 5, a pump 7, an oil cooler (O/C) 8, a four-way valve 6, a battery heater 13, and a battery 14.

The first flow path 4a sequentially connects the reservoir tank 5, the pump 7, the oil cooler 8, and the four-way valve 6. The third flow path 4c sequentially connects the four-way valve 6, the battery heater 13, the battery 14, and the reservoir tank 5.

In the first circuit 3a, the heat medium sequentially flows through the reservoir tank 5, the pump 7, the oil cooler 8, the four-way valve 6, the battery heater 13, and the battery 14.

The second circuit 3b includes a second flow path 4b, a third flow path 4c, a reservoir tank 5, a pump 10, a radiator 12, a four-way valve 6, a battery heater 13, and a battery 14.

The second flow path 4b sequentially connects the reservoir tank 5, the pump 10, the radiator 12, and the four-way valve 6.

In the second circuit 3b, the heat medium sequentially flows through the reservoir tank 5, the pump 10, the radiator 12, the four-way valve 6, the battery heater 13, and the battery 14.

The third circuit 3c includes a first flow path 4a, a fourth flow path 4d, a reservoir tank 5, a pump 7, an oil cooler 8, and a four-way valve 6.

The fourth flow path 4d sequentially connects the four-way valve 6 and the reservoir tank 5.

In the third circuit 3c, the heat medium sequentially flows through the reservoir tank 5, the pump 7, the oil cooler (O/C) 8, and the four-way valve 6.

The fourth circuit 3d includes a second flow path 4b, a fourth flow path 4d, a pump 10, a radiator 12, and a four-way valve 6.

In the fourth flow path 4d, the heat medium sequentially flows through the reservoir tank 5, the pump 10, the radiator 12, and the four-way valve 6.

The four-way valve 6 switches the path of the heat medium. The four-way valve 6 has four-ports P1 to P4. The port P1, the port P2, the port P3, and each of the port P4 are connected to the first flow path 4a, the second flow path 4b, the third flow path 4c, and the fourth flow path 4d. Note that each port is formed so as to be connectable to each other.

The radiator 12 is formed so as to be able to cool a heat medium having a high temperature by heat exchange with outside air.

The heat management device 2 further includes a fifth circuit 3e. The fifth circuit 3e includes a fifth flow path 4e, a reservoir tank 15, an electric oil pump (EOP) 16, an oil cooler 8, and a drive device 18. The drive device 18 includes a motor 18a and a gear 18b. Note that the motor 18a is an exemplary “rotary electric machine” disclosed herein.

The fifth flow path 4e sequentially connects the reservoir tank 15, the electric oil pump 16, the oil cooler 8, the motor 18a, and the gear 18b.

In the fifth circuit 3e, the cooling oil sequentially flows through the reservoir tank 15, the electric oil pump 16, the oil cooler 8, the motor 18a, and the gear 18b. The cooling oil is an example of the “refrigerant” of the present disclosure.

The oil cooler 8 is formed so as to allow heat exchange between the heat medium flowing in the oil cooler 8 and the cooling oil. In the first circuit 3a, the heat medium heated by the battery heaters 13 raises the temperature of the battery 14. In the oil cooler 8, the cooling oil heats the heat medium, so that the energy consumption of the battery heater 13 can be suppressed.

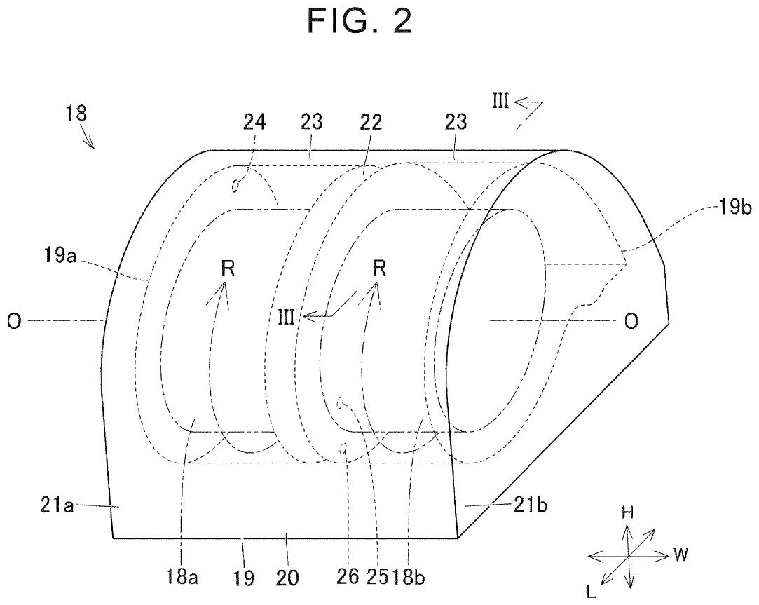

Details of the drive device 18 are shown below. FIG. 2 is a perspective view of the drive device according to the present embodiment. The width direction W, the length direction L, and the height direction H in the drawing respectively indicate the width direction, the length direction, and the height direction of the drive device.

Incidentally, the outer shape of the housing case 19 forming the drive device 18 shown in FIG. 2 is an example, the shape of the housing case 19 can take various shapes.

The drive device 18 further includes a housing case 19. The housing case 19 includes a bottom plate 20, a side wall 21a, a side wall 21b, a partition wall 22, and a peripheral wall 23.

The side wall 21a and the side wall 21b are arranged in the width direction W. The side walls 21a, 21b are formed so as to rise upward from an outer peripheral edge portion of the bottom plate 20. The peripheral wall 23 is formed to connect an outer peripheral edge portion between the side wall 21a and the side wall 21b.

A space is formed in the housing case 19, and the space is partitioned into a first housing chamber 19a and a second housing chamber 19b by a partition wall 22. The second housing chamber 19b is an exemplary “housing chamber” disclosed herein.

The first housing chamber 19a and the second housing chamber 19b are arranged in the width direction W. The motor 18a is accommodated in the first housing chamber 19a, and the gear 18b is accommodated in the second housing chamber 19b.

The motor 18a includes a stator and a rotor, and the rotor is provided so as to be rotatable about a rotation center line O. The gear 18b is connected to the rotor of the motor 18a, and the gear 18b is formed so as to rotate about the rotation center line O. The rotor and the gear 18b of the motor 18a rotate in the rotation direction R.

In the housing case 19, an inflow port 24 and contact ports 25 and 26 are formed.

Note that the contact port 25 is an example of the “first opening portion” of the present disclosure. The contact port 26 is an example of a “second opening” of the present disclosure.

The inflow port 24 is formed in the side wall 21a. The inflow port 24 connects the fifth flow path 4e and the first housing chamber 19a shown in FIG. 1. Accordingly, the coolant oil circulating in the fifth circuit 3e flows into the first housing chamber 19a through the inflow port 24.

The contact ports 25 and 26 are formed in the partition wall 22. The contact ports 25 and 26 communicate the first housing chamber 19a and the second housing chamber 19b, respectively. The contact port 25 and the contact port 26 are formed to be arranged in the height direction H. The contact port 25 is located above the contact port 26.

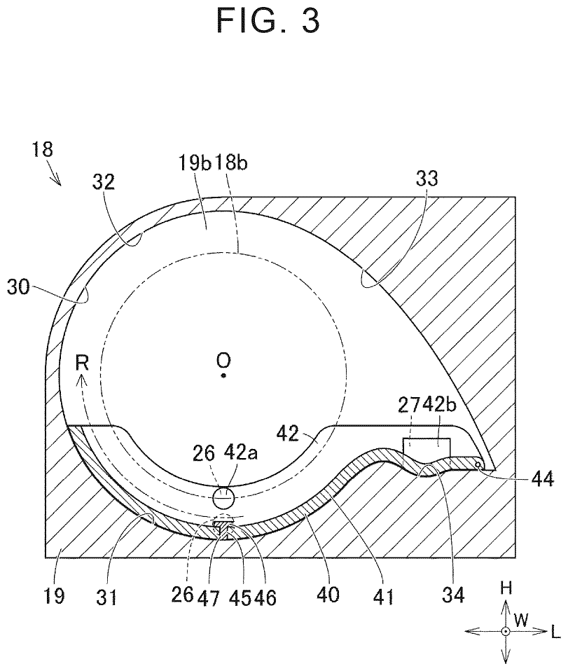

FIG. 3 shows a cross-sectional view of III-III of FIG. 2. The second housing chamber 19b is formed by the inner peripheral surface 30. The inner peripheral surface is an example of the “inner surface” of the present disclosure.

The inner peripheral surface 30 includes a bottom surface 31, an arc surface 32, a connecting surface 33, and a base surface 34. The bottom surface 31 is an arc surface centered on the rotation center line O.

The bottom surface 31 is located at the bottom of the inner peripheral surface 30, and is located below the gear 18b. A plate 40, which will be described later, is disposed on the bottom surface 31.

The arc surface 32 is located on the front side in the rotation direction R with respect to the bottom surface 31. The arc surface 32 is also formed in an arc surface shape about the rotation center line O. The arc surface 32 includes a portion adjacent to the gear 18b in the width direction W, an upper portion located above the gear 18b, and a portion located on the front side in the rotation direction R from the upper portion and adjacent to the gear 18b in the width direction W.

The connecting surface 33 is located on the front side in the rotation direction R with respect to the arc surface 32, and is formed in a substantially straight line shape.

The base surface 34 is located on the rear side in the rotation direction R with respect to the bottom surface 31. When the lowermost portion of the bottom surface 31 is a bottom portion, the base surface 34 is positioned higher than the bottom portion. In the embodiment illustrated in FIG. 3, the base surface 34 is positioned above the lower end portion of the gear 18b.

Further, an outflow port 27 is formed in the housing case 19. The outflow port 27 is formed in a portion of the partition wall 22 located at the lowermost position of the base surface 34. The outflow port 27 connects the second housing chamber 19b and the fifth flow path 4e illustrated in FIG. 1. Thus, the cooling oil circulating in the fifth circuit 3e absorbs heat generated by driving the motor 18a and the gear 18b, and is discharged from the outflow port 27.

The housing case 19 further includes a plate 40 and a displacement member 45 in the second housing chamber 19b.

The displacement member 45 is provided at the bottom, which is the lowermost portion of the plate 40, in a state in which the plate 40 is in contact with the bottom surface 31. The displacement member 45 is fixed to the plate 40. The displacement member 45 is, for example, a known thermoelement formed of an elastic body such as a spring and a thermally expandable material such as paraffin wax. The displacement member 45 is formed of a temperature sensing portion 46 and an output portion 47.

The temperature sensing portion 46 is disposed so as to be exposed from the upper surface of the plate 40. The output portion 47 is formed so as to extend downward from the temperature sensing portion 46. The output portion 47 is formed to be stretchable in the height direction H. The lower end portion of the output portion 47 is in contact with the bottom surface 31.

When the temperature sensing portion 46 is heated by the high-temperature cooling oil, heat is transferred from the temperature sensing portion 46 to the output portion 47, and the output portion 47 is deformed so as to extend. Due to the expansion and contraction of the displacement member 45, the plate 40 performs a rotational motion about the rotation shaft 44.

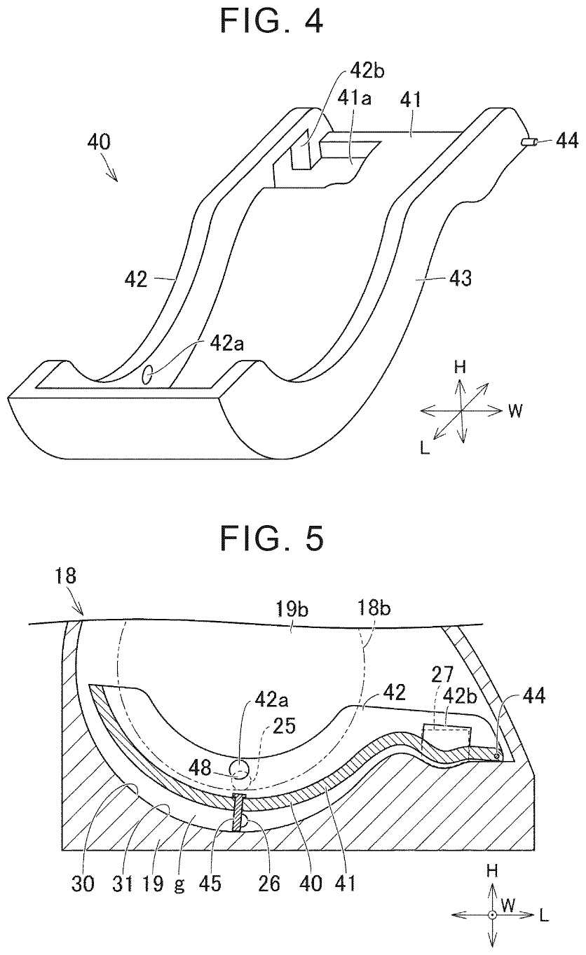

FIG. 4 is a perspective view schematically showing a plate. The plate 40 is formed of a bottom plate 41, a side wall 42, and a side wall 43.

The bottom plate 41 is a plate-like member formed so as to cover the bottom surface 31 and the base surface 34 of the inner peripheral surface 30. The displacement member 45 shown in FIG. 3 is provided at a position located at the lowermost position of the bottom plate 41 in a state where the plate 40 is in contact with the bottom surface 31. A cutout portion 41a is formed in an area of the bottom plate 41 facing the outflow port 27.

The side wall 42 and the side wall 43 are arranged at intervals in the width direction W, are formed so as to rise from the outer peripheral edge portion of the bottom plate 41, and are formed so as to extend along the outer peripheral edge portion of the bottom plate 41.

The side walls 42 are arranged along the partition wall 22 shown in FIG. 2. An opening 42a and a cutout portion 42b are formed in the side wall 42. The side wall 43 is arranged along the side wall 21b shown in FIG. 2.

In the position where the plate 40 contacts the bottom surface 31, the opening 42a is formed in an area facing the contact port 25 of the partition wall 22. The cutout portion 42b is formed in an area of the partition wall 22 facing the outflow port 27.

A rotation shaft 44 is formed on the plate 40 at one end in the length direction L and in the vicinity of the cutout portion 42b. The plate 40 is formed so as to be rotatable about the rotation shaft 44.

In the above-described embodiment, the drive device 18 has the first housing chamber 19a and the second housing chamber 19b formed in the housing case 19. The partition wall 22 partitions the first housing chamber 19a and the second housing chamber 19b. A contact port 25 and a contact port 26 that communicate the first housing chamber 19a and the second housing chamber 19b are formed in the partition wall 22. The contact port 26 is formed below the contact port 25. Plate 40 is disposed in the second housing chamber 19b. In a state in which the plate 40 is in contact with the bottom surface 31, the contact port 26 is closed by the plate 40.

In such a configuration, by displacing the plate 40 by the deformation of the displacement member 45, it is possible to adjust the amount of heat dissipation of the coolant oil in the second housing chamber 19b. Accordingly, it is possible to provide the drive device 18 that can effectively utilize the heat generated from the drive device 18. Details are described below.

Referring again to FIG. 3. FIG. 3 shows the plate 40 in contact with the bottom surface 31. In a position where the plate 40 contacts the bottom surface 31, the coolant oil flowing into the second housing chamber 19b through the contact port 25 passes through the upper surface of the plate and is discharged to the outside of the drive device 18 through the outflow port 27. During this time, the heat of the cooling oil inside the second housing chamber 19b passes through the plate 40 and the housing case 19, and is dissipated to the outside.

Reference is now made to FIG. 5. FIG. 5 shows a state in which a gap g is formed between the bottom surface 31 and the plate 40. The cooling oil having a predetermined temperature or higher heats the displacement member 45 provided at the bottom of the plate 40. By heating, the output portion 47 extends in the height direction. As a result, the plate 40 is displaced by the rotational movement about the rotation shaft 44. Thus, a gap g is formed between the bottom surface 31 and the plate 40. In addition, the contact port 26 closed by the plate 40 communicates the first housing chamber 19a and the second housing chamber 19b shown in FIG. 2, and the coolant oil flows into the gap g. Then, the coolant oil, which is a gap g, flows on the bottom surface 31 and is discharged to the outside of the drive device 18 through the cutout portion 41a, the cutout portion 42b, and the outflow port 27 shown in FIG. 4. During this time, the heat of the cooling oil inside the second housing chamber 19b passes through the housing case 19 and is dissipated to the outside.

The predetermined temperature is, for example, a temperature at which a gap starts to be formed between the bottom surface 31 and the plate 40 by the output portion 57 being extended by heating of the displacement member 45.

In the heat dissipation of the cooling oil in the second housing chamber 19b, a state in which the gap g is formed has a lower thermal resistivity than a state in which the plate 40 is in contact with the bottom surface 31. This is because, in each state, the heat conduction paths are different. Accordingly, the heat dissipation amount of the coolant oil in the second housing chamber 19b can be adjusted by switching the state in which the gap g is formed and the state in which the plate 40 is in contact with the bottom surface 31 by the expansion and contraction of the displacement member 45.

More specifically, by setting the plate 40 in a position in contact with the bottom surface 31, heat dissipation of the cooling oil can be suppressed. As a result, the amount of heat exchange performed by the cooling oil as the heat medium in the oil cooler 8 can be increased, and the amount of energy consumed by the battery heater 13 can be suppressed. As a result, it is possible to provide the drive device 18 capable of effectively utilizing the heat generated from the drive device 18.

Alternatively, it is possible to promote heat dissipation of the cooling oil by setting the gap g to be formed. As a result, the amount of heat applied to the heat medium by the cooling oil in the oil cooler 8 can be suppressed. As a result, the amount of heat dissipation of the heat medium required for the radiator 12 can be suppressed, and an increase in the size of the radiator 12 can be suppressed.

In addition, since the gap g is formed, the cooling oil flowing through the upper surface of the plate 40 is reduced, so that the energy-loss caused by the stirring of the cooling oil in the gear 18b can be suppressed.

By using the plate 40 made of a material having a lower thermal conductivity, heat dissipation of the cooling oil can be suppressed more. This is because, in the position where the plate 40 contacts the bottom surface 31, the cooling oil in the second housing chamber 19b dissipates heat to the outside. The material having a low thermal conductivity is, for example, a material having a lower thermal conductivity than the material forming the housing case 19. When the housing case 19 is formed of a metal material, a resin material or the like may be used as the material of the plate 40.

Similarly, by making the thickness of the plate 40 hot, heat dissipation of the cooling oil can be further suppressed.

The opening area of the contact port 25 may be larger than that of the contact port 26. With such a configuration, the flow rate of the cooling oil flowing through the upper surface of the bottom plate 41 can be made larger than the flow rate of the cooling oil flowing through the gap g. As a consequence, it is possible to suppress an increase in the temperature of the gear 18b.

In the above-described embodiment, an opening 42a is formed in the side wall 42 of the plate 40. In a position where the plate 40 contacts the bottom surface 31, the opening 42a is formed in an area facing the contact port 25 formed in the partition wall 22. In addition, the contact port 26 is closed by the plate 40 in a state where the plate 40 is in contact with the bottom surface 31.

With such a configuration, as shown in FIG. 5, the area of the overlapping part 48 between the contact port 25 and the opening 42a can be adjusted in accordance with the displacement of the plate 40 around the rotation shaft 44. In addition, the opening area of the contact port 26 closed by the plate 40 can also be adjusted. Accordingly, the amount of cooling oil passing through the contact port 26 and the amount of cooling oil passing through the contact port 25 and the opening 42a can be adjusted in accordance with the displacement of the plate 40.

In the above embodiment, the plate 40 is displaced about the rotation shaft 44, but the present disclosure is not limited thereto. For example, the position of the plate 40 may be fixed in a state where the gap g is formed. In this case, a flow path switching valve is provided at the bottom of the bottom plate 41 of the plate 40.

The flow path switching valve is a valve that opens and closes in accordance with the temperature of the cooling oil. By opening and closing the flow path switching valve, it is possible to switch whether or not the cooling oil flowing through the upper surface of the bottom plate 41 flows into the gap g. The flow path switching valve is, for example, a known thermoelement formed of an elastic body such as a spring and a thermally expandable material such as paraffin wax. The flow path switching valve is an example of a “switching device” of the present disclosure.

In such a configuration, when the flow path switching valve is closed, the coolant oil flowing from the contact port 25 into the second housing chamber 19b flows through the upper surface of the bottom plate 41 and is discharged from the outflow port 27. That is, the cooling oil does not pass through the gap g. During this time, the heat of the cooling oil inside the second housing chamber 19b is dissipated to the outside through the plate 40, the gap of the gap g, and the housing case 19. When the cooling oil stays in the gap g, heat of the cooling oil is dissipated to the outside by passing the cooling oil instead of the gap.

The flow path switching valve heated by the cooling oil having a predetermined temperature or higher opens the valve. As a result, the cooling oil flows into the gap g. Then, the coolant oil, which is a gap g, flows on the bottom surface 31 and is discharged to the outside of the drive device 18 through the cutout portion 41a, the cutout portion 42b, and the outflow port 27 shown in FIG. 4. During this time, the heat of the cooling oil inside the second housing chamber 19b passes through the housing case 19 and is dissipated to the outside.

The predetermined temperature is, for example, a temperature at which the flow path switching valve starts to open due to heating of the flow path switching valve.

In the heat dissipation of the cooling oil in the second housing chamber 19b, a state in which the cooling oil does not pass through the gap g due to the closing of the flow path switching valve has a larger thermal resistivity than a state in which the cooling oil passes through the gap g due to the opening of the flow path switching valve. This is because, in each state, the heat conduction paths are different. Therefore, the amount of heat dissipation of the cooling oil in the second housing chamber 19b can be adjusted by switching the opening and closing of the flow path switching valve in accordance with the temperature of the cooling oil.

More specifically, when the flow path switching valve is closed and the cooling oil does not pass through the gap g, heat dissipation of the cooling oil can be suppressed. As a result, it is possible to provide the drive device 18 that can effectively utilize the heat generated from the drive device 18.

Alternatively, the heat dissipation of the cooling oil can be promoted by setting the cooling oil to pass through the gap g by opening the flow path switching valve. As a result, the amount of heat dissipation of the heat medium required for the radiator 12 can be suppressed.

In the above-described embodiment, the cooling oil flows into the gap g to promote heat dissipation of the cooling oil in the second housing chamber 19b to the outside, but the present disclosure is not limited thereto. For example, heat dissipation of the cooling oil flowing into the second housing chamber 19b may be promoted by a configuration in which the cooling oil does not flow into the gap g.

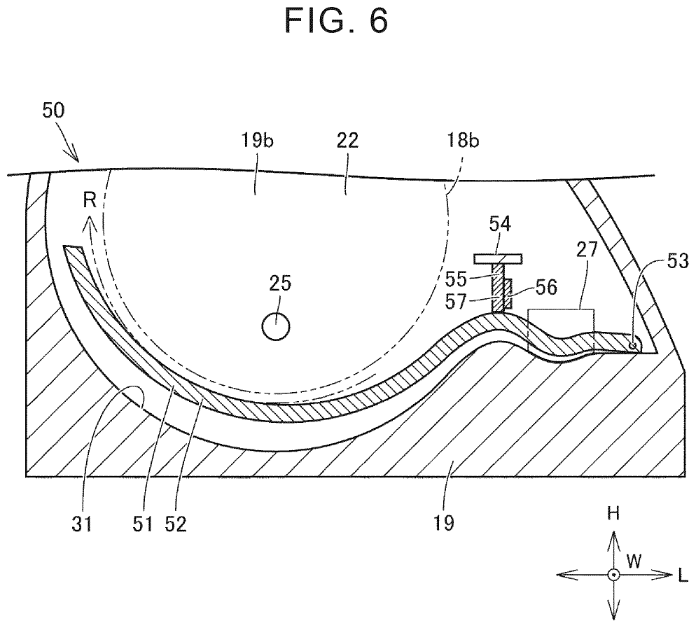

FIG. 6 is a cross-sectional view of a drive device according to a modification of the present embodiment. The drive device 50 is formed in the same configuration as the drive device 18 according to the present embodiment unless otherwise described below.

The drive device 50 includes a plate 51 in the second housing chamber 19b. The plate 51 has a bottom plate 52. A rotation shaft 53 is formed at one end in the length direction L of the bottom plate 52 and on the rear side in the rotation direction R with respect to the bottom surface 31. The second housing chamber 19b is provided with a support member 54 and a displacement member 55.

The support member 54 is formed to extend in the width direction W. The displacement member 55 is provided below the support member 54. The displacement member 55 is, for example, a known thermoelement formed of an elastic body such as a spring and a thermally expandable material such as paraffin wax. The displacement member 55 includes a temperature sensing portion 56 and an output portion 57. The temperature sensing portion 56 is provided in the output portion 57. The output portion 57 is formed to extend in the height direction H. One end and the other end of the output portion 57 in the height direction are connected to the support member 54 and the bottom plate 52, respectively. The plate 51 is held by the displacement member 55 so as to be maintained in a state in which a gap g is formed between the plate and the bottom surface 31.

In such a configuration, the cooling oil having reached the predetermined temperature or more heats the temperature sensing portion 56, so that the output portion 57 is deformed so as to extend in the height direction H. In response to the extension of the output portion 57, the plate 51 is displaced and comes into contact with the bottom surface 31. As described above, the plate 51 performs the rotational movement about the rotation shaft 53 by the expansion and contraction of the output portion 57. That is, the displacement member 55 can displace the plate 51 between a position where the gap g is formed between the plate 51 and the bottom surface 31 and a position where the plate 51 contacts the bottom surface 31.

The predetermined temperature is, for example, a temperature at which the output portion 57 is extended by heating of the displacement member 55 and the bottom surface 31 and the plate 51 are in contact with each other.

The temperature of the cooling oil in a state where the plate 51 is in contact with the bottom surface 31 is higher than the temperature of the cooling oil in a state where the gap g is formed between the plate 51 and the bottom surface 31.

In the drive device 50, the coolant oil flowing into the second housing chamber 19b through the contact port 25 passes through the upper surface of the plate 51 and is discharged to the outside of the drive device 18 through the outflow port 27.

When the plate 51 is at the position where the gap g is formed, the heat of the cooling oil inside the second housing chamber 19b is dissipated to the outside through the plate 51, the gap of the gap g, and the housing case 19. When the plate 51 is at a position contacting the bottom surface 31, the heat of the coolant oil inside the second housing chamber 19b passes through the plate 51 and the housing case 19 and is dissipated to the outside.

As described above, the heat dissipation path of the coolant oil in the second housing chamber 19b differs depending on the position of the plate 51. The heat dissipation path of the cooling oil in a state where the plate 51 is in contact with the bottom surface 31 has a smaller thermal resistance than a state where the plate 51 is in a position where the gap g is formed. Therefore, the heat dissipation of the cooling oil can be promoted by placing the plate 51 in a position in contact with the bottom surface 31. By displacing the plate 51 in accordance with the temperature of the coolant oil, it is possible to provide the drive device 50 that can effectively utilize the heat generated from the motor 18a and the gear 18b.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A drive device comprising:
a housing case;
a rotary electric machine provided in the housing case;
a gear rotatably provided in the housing case; and
a refrigerant for cooling the rotary electric machine, wherein
the housing case has a housing chamber that houses the rotary electric machine and the gear,
the housing case includes a plate provided in the housing chamber, and a displacement member configured to displace the plate,
the plate is displaceable between a position where the plate is in contact with an inner surface of the housing case that defines the housing chamber and a position where a clearance is secured between the plate and the inner surface, and
the refrigerant passes along the plate while the plate is at the position where the plate is in contact with the inner surface that defines the housing chamber.

2. The drive device according to claim 1, wherein the refrigerant passes along the clearance while the clearance is secured between the plate and the inner surface.

3. The drive device according to claim 2, wherein:
the housing chamber includes a first housing chamber that houses the rotary electric machine, and a second housing chamber that houses the gear;
the housing case includes a partition wall that defines the first housing chamber and the second housing chamber;
the partition wall has a first opening and a second opening positioned below the first opening;
the plate is provided on a bottom side of the second housing chamber;
while the plate is in contact with the inner surface, the second opening is closed by the plate, and the refrigerant flows into the second housing chamber through the first opening and flows along an upper surface of the plate positioned in the second housing chamber; and
while the clearance is secured between the inner surface and the plate, the second opening communicates with the clearance, and the refrigerant passes along the clearance through the second opening.

4. The drive device according to claim 1, wherein:
the displacement member is configured to, when a temperature of the refrigerant increases, displace the plate into contact with the inner surface of the housing case; and
a temperature of the refrigerant while the plate is in contact with the inner surface of the housing case that defines the housing chamber is higher than a temperature of the refrigerant while the clearance is secured between the plate and the inner surface of the housing case that defines the housing chamber.

5. A drive device comprising:
a housing case;
a rotary electric machine provided in the housing case;
a gear rotatably provided in the housing case;
a refrigerant for cooling the rotary electric machine; and
a switching device, wherein
the housing case has a housing chamber that houses the rotary electric machine and the gear,
the housing case includes a plate provided in the housing chamber,
the plate is disposed in the housing chamber,
a clearance is secured between the plate and an inner surface of the housing case,
the switching device is configured to switch a state in which the refrigerant passes along the clearance and a state in which the refrigerant does not pass along the clearance, and
a temperature of the refrigerant in the state in which the refrigerant passes along the clearance is higher than a temperature of the refrigerant in the state in which the refrigerant does not pass along the clearance.
